(19) United States
(12) Patent Application Publication
(10) Pub. No.: US 2026/0098501 A1
(43) Pub. Date: Apr. 9, 2026

(54) CONTROLLER FOR INTERNAL COMBUSTION ENGINE

(71) Applicant: TOYOTA JIDOSHA KABUSHIKI KAISHA, Toyota-shi (JP)

(72) Inventor: Kuniyuki SASAKI, Okazaki-shi (JP)

(21) Appl. No.: 19/348,815

(22) Filed: Oct. 3, 2025

(30) Foreign Application Priority Data
Oct. 8, 2024 (JP) 2024-176466

(51) Int. Cl. F02D 41/14; F01N 3/10; F02D 1/02

(52) U.S. Cl. CPC F02D 41/1454; F01N 3/101; F02D 1/02; F02D 41/1441; F02D 2200/0611

(57) ABSTRACT

Processing circuitry is configured to execute a first process that calculates an imbalance index value indicating a degree of variation in air-fuel ratios across multiple cylinders, a second process that calculates a target air-fuel ratio by correcting a reference air-fuel ratio based on the imbalance index value, a third process that causes fuel injection valves to inject fuel in an amount corresponding to the target air-fuel ratio, and a fourth process that stops the operation of the internal combustion engine when a stop condition is met. The processing circuitry is configured to repeat, when a continuation condition is met, the first to third processes without stopping the operation of the internal combustion engine until a termination condition is met even if the stop condition is met. The continuation condition is a condition indicating a sign of an anomaly related to variations in air-fuel ratios across the cylinders.

### CROSS-REFERENCE TO RELATED APPLICATIONS

This application is based upon and claims the benefit of priority from Japanese Patent Application No. 2024-176466, filed on October 8, 2024, the entire contents of which are incorporated herein by reference.

### BACKGROUND

### 1. Field

The present disclosure relates to a controller for an internal combustion engine.

### 2. Description of Related Art

JP2012-97671A discloses an internal combustion engine that includes multiple cylinders, fuel injection valves provided for the respective cylinders, an exhaust passage, and an air-fuel ratio sensor. The exhaust passage is connected to each cylinder. The air-fuel ratio sensor is positioned in the exhaust passage. The air-fuel ratio sensor detects the air-fuel ratio of exhaust gas discharged from the cylinders. A combustion cycle refers to a sequence of events during which each of the multiple cylinders undergoes a combustion stroke once. A controller for an internal combustion engine calculates an imbalance index value indicative of the degree of variation in air-fuel ratios across multiple cylinders based on changes in detection values of the air-fuel ratio sensor over a specified period spanning multiple combustion cycles. When the imbalance index value is calculated, the controller stores the imbalance index value in memory. In each combustion cycle, the controller calculates a target air-fuel ratio based on the most recent imbalance index value stored in the memory. The controller then calculates a commanded injection amount for each fuel injection valve based on the target air-fuel ratio.

The internal combustion engine and the controller, as disclosed in the aforementioned publication, may be implemented in a hybrid electric vehicle. In a hybrid electric vehicle, a motor generator, serving as a drive source distinct from the internal combustion engine, can propel the vehicle, resulting in frequent intermittent stopping of the internal combustion engine. As a result, it may become difficult to calculate an appropriate imbalance index value. Consequently, if the target air-fuel ratio and thus the commanded injection amount are calculated based on an inaccurate imbalance index value, there is a risk that exhaust emissions may deteriorate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for an internal combustion engine is provided. The internal combustion engine includes an engine main body having multiple cylinders, and fuel injection valves provided for the respective cylinders. The controller includes processing circuitry. The processing circuitry is configured to execute, during operation of the internal combustion engine, a first process that calculates an imbalance index value indicating a degree of variation in air-fuel ratios across the cylinders based on changes in a parameter indicating an operation state of the internal combustion engine in a preset period determined in advance, a second process that calculates a target air-fuel ratio by correcting a predetermined reference air-fuel ratio based on the most recent imbalance index value, a third process that causing each of the fuel injection valves to inject fuel in a commanded injection amount corresponding to the most recent target air-fuel ratio, and a fourth process that stops the operation of the internal combustion engine when a predetermined stop condition is met. The processing circuitry is configured to repeat, when a predetermined continuation condition is met, the first process, the second process, and the third process without stopping the operation of the internal combustion engine until a predetermined termination condition is met even if the stop condition is met, the continuation condition being a condition indicating a sign of an anomaly related to variations in air-fuel ratios across the cylinders.

Other features and aspects will be apparent from the following detailed description, the drawings, and the claims.

### BRIEF DESCRIPTION OF THE DRAWINGS

FIG. 1 is a schematic diagram showing the configuration of a vehicle.

FIG. 2 is a flowchart showing a procedure of a stopping process executed by a controller mounted on the vehicle shown in FIG. 1.

FIG. 3 is a flowchart showing a procedure of a flag setting process executed by the controller mounted on the vehicle shown in FIG. 1.

FIG. 4 is a diagram showing the contents of injection control executed by the controller mounted on the vehicle shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Overall Configuration

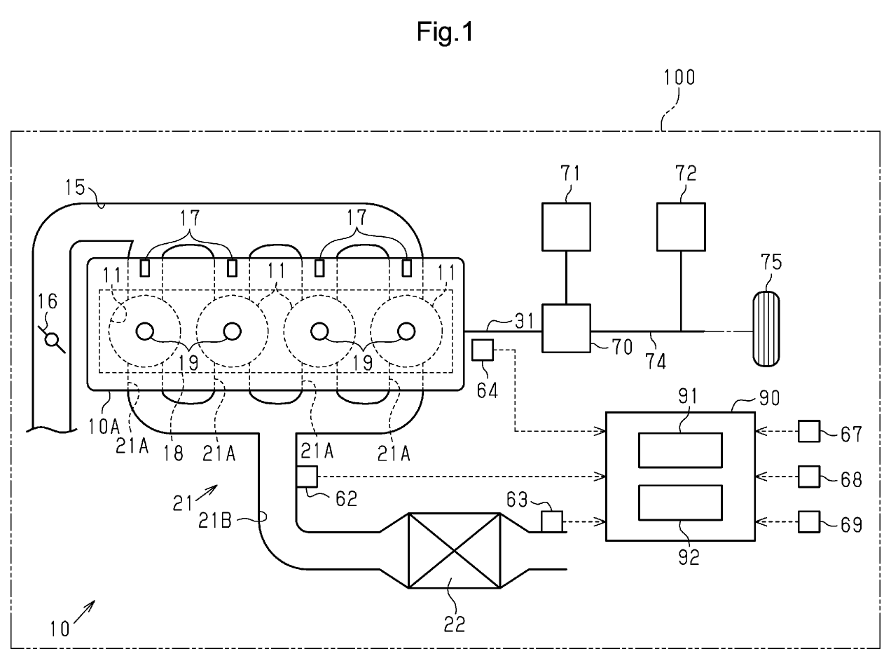

Hereinafter, an embodiment of a controller 90 of the internal combustion engine 10 will be described with reference to the drawings. As shown in FIG. 1, the vehicle 100 includes an internal combustion engine 10, a first motor generator 71, a second motor generator 72, a planetary gear mechanism 70, a drive shaft 74, and drive wheels 75. The vehicle 100 is a hybrid electric vehicle that uses an internal combustion engine 10, a first motor generator 71, and a second motor generator 72 as drive sources.

The internal combustion engine 10 inputs torque to the planetary gear mechanism 70. The planetary gear mechanism 70 distributes the torque from the internal combustion engine 10 to the first motor generator 71 and the drive shaft 74. The first motor generator 71 generates electric power in accordance with the torque distributed to the first motor generator 71 by the planetary gear mechanism 70. The drive shaft 74 transmits the torque distributed to the drive shaft 74 by the planetary gear mechanism 70 to the drive wheels 75. The second motor generator 72 inputs torque to the drive shaft 74. This torque is transmitted to the drive wheels 75. An example of a vehicle having this type of configuration is described in JP2022-166473A.

The internal combustion engine 10 includes an engine main body 10A, a crankshaft 31, and a crank angle sensor 64. The engine main body 10A has four cylinders 11. The cylinders 11 are formed as spaces partitioned in the engine main body 10A. In each cylinder 11, an air-fuel mixture of fuel and intake air is combusted by a spark plug 19 provided for each cylinder 11. The crankshaft 31 rotates in response to the combustion of the air-fuel mixture. The crank angle sensor 64 outputs a signal corresponding to the rotational position of the crankshaft 31. The engine main body 10A is provided with water jacket 18 through which coolant flows.

The internal combustion engine 10 includes an intake passage 15, a throttle valve 16, and a fuel injection valve 17 provided for each cylinder 11. The intake passage 15 is a passage for introducing intake air into each cylinder 11. The throttle valve 16 adjusts the amount of intake air. The fuel injection valve 17 injects fuel to supply the fuel into the corresponding cylinder 11.

The internal combustion engine 10 includes an exhaust passage 21 and a three-way catalyst 22. The exhaust passage 21 is a passage through which the exhaust gas discharged from each cylinder 11 flows. The exhaust passage 21 includes an individual passage 21A provided for each of the cylinders 11 and a merging passage 21B. The multiple individual passages 21A extend from the corresponding cylinders 11 and merge at the upstream end of the merging passage 21B. The three-way catalyst 22 is located in the middle of the merging passage 21B. In other words, the three-way catalyst 22 is located in a portion of the exhaust passage 21 downstream of the merging point of the individual passages 21A. The three-way catalyst 22 purifies hydrocarbon, carbon monoxide, and nitrogen oxide that are contained in exhaust gas.

The internal combustion engine 10 is provided with an upstream air-fuel ratio sensor 62 and a downstream air-fuel ratio sensor 63. The upstream air-fuel ratio sensor 62 is positioned at a portion of the merging passage 21B on the upstream side of the three-way catalyst 22. The air-fuel ratio of the exhaust gas flowing through a portion of the exhaust passage 21 between the merging point of the individual passages 21A and the three-way catalyst 22 is referred to as an upstream air-fuel ratio AF1. The upstream air-fuel ratio AF1 can also be said to be the air-fuel ratio of the exhaust gas flowing into the three-way catalyst 22. The upstream air-fuel ratio sensor 62 outputs a signal having a voltage value corresponding to the upstream air-fuel ratio AF1. As the upstream air-fuel ratio AF1 changes from rich to lean, the voltage outputted from the upstream air-fuel ratio sensor 62 increases linearly in proportion to the upstream air-fuel ratio AF1. The downstream air-fuel ratio sensor 63 is positioned at a portion of the merging passage 21B on the downstream side of the three-way catalyst 22. The air-fuel ratio of the exhaust gas flowing through a portion of the merging passage 21B downstream of the three-way catalyst 22 is referred to as a downstream air-fuel ratio AF2. The downstream air-fuel ratio sensor 63 outputs a signal having a voltage value corresponding to the downstream air-fuel ratio AF2. The downstream air-fuel ratio sensor 63 is an oxygen sensor whose output voltage greatly changes with the stoichiometric air-fuel ratio as a boundary. An example of the detailed structure of the upstream air-fuel ratio sensor 62 and the downstream air-fuel ratio sensor 63 is disclosed in JP2012-97671A.

The vehicle 100 includes a start switch 67, an accelerator sensor 68, and a vehicle speed sensor 69. The start switch 67 is a switch for the user to turn on or off the main system of the vehicle 100. Hereinafter, a period from when the start switch 67 is turned on to when the start switch 67 is turned off is referred to as one trip. The accelerator sensor 68 outputs a signal corresponding to an operation amount of an accelerator pedal of the vehicle 100. The vehicle speed sensor 69 outputs a signal corresponding to the traveling speed of the vehicle 100.

The vehicle 100 includes a controller 90. The controller 90 is a computer including a processing circuitry. The processing circuitry includes a CPU 91 and a memory 92. The memory 92 includes three types of storage devices: a RAM, a ROM, and an electrically rewritable nonvolatile memory. In the present embodiment, these three types of storage devices are collectively referred to as a memory 92. The memory 92 stores in advance various programs describing processes to be executed by the CPU 91. The memory 92 stores in advance various kinds of information necessary for the CPU 91 to execute the program.

The controller 90 repeatedly acquires signals from various sensors provided in the vehicle 100. The CPU 91 calculates necessary parameters at any time based on the acquired signals. For example, the CPU 91 converts the signal output by the upstream air-fuel ratio sensor 62 into the upstream air-fuel ratio AF1 in accordance with the voltage value of the signal. The CPU 91 calculates an engine rotation speed that is a rotation speed of the crankshaft 31 based on the signal from the crank angle sensor 64. The CPU 91 uses the voltage value acquired from the downstream air-fuel ratio sensor 63 as it is for each process. The CPU 91 also processes signals from each of the other sensors. Examples of other sensors are an air flow meter and a cam angle sensor. The air flow meter outputs a signal corresponding to the intake air amount. The cam angle sensor outputs a signal corresponding to a rotational position of an intake camshaft that drives the intake valve. As described in JP2012-97671A, the CPU 91 can calculate a crank angle, which is a rotation angle of the crankshaft 31, by combining a signal from the crank angle sensor 64 and a signal from the cam angle sensor. The crank angle takes a value from 0 degrees to 720 degrees with reference to a specified rotational position of the crankshaft 31.

The CPU 91 controls the internal combustion engine 10, the first motor generator 71, and the second motor generator 72. The CPU 91 repeatedly calculates the vehicle-requested torque required for the traveling of the vehicle 100 based on the operation amount of the accelerator pedal and the traveling speed of the vehicle 100 during one trip. After calculating the vehicle-requested torque, the CPU 91 allocates the vehicle-requested torque to the internal combustion engine 10, the first motor generator 71, and the second motor generator 72. The CPU 91 controls each of the internal combustion engine 10, the first motor generator 71, and the second motor generator 72 on the basis of the allocated torque.

The CPU 91 operates the internal combustion engine 10 or stops the operation of the internal combustion engine 10 according to the torque allocated to the internal combustion engine 10 during one trip. When the internal combustion engine 10 is operated, the CPU 91 performs various controls for burning the air-fuel mixture in each of the cylinders 11. The various types of control include ignition timing control for controlling the ignition timing of the spark plug 19, injection control J for controlling the injection of fuel by the fuel injection valve 17, and opening degree control for controlling the opening degree of the throttle valve 16. The CPU 91 sequentially burns the air-fuel mixture in each of the cylinders 11 through these various controls. Hereinafter, a series of periods in which each of the cylinders 11 undergoes a combustion stroke once is referred to as one combustion cycle. One combustion cycle is a period in which the crank angle reaches 720 degrees from 0 degrees.

The CPU 91 can execute various processes including a first process to a fourth process which will be described later as processes for controlling the internal combustion engine 10. The CPU 91 can execute a stopping process as one of the processes for controlling the internal combustion engine 10. When a predetermined stop condition is met during the operation of the internal combustion engine 10, the CPU 91 starts the stopping process. For example, the stop condition is that the vehicle requested torque is less than or equal to a specified torque. The specified torque is determined in advance as a value of torque that can be generated only by the first motor generator 71 and the second motor generator 72 and that can achieve a vehicle state corresponding to a user's request.

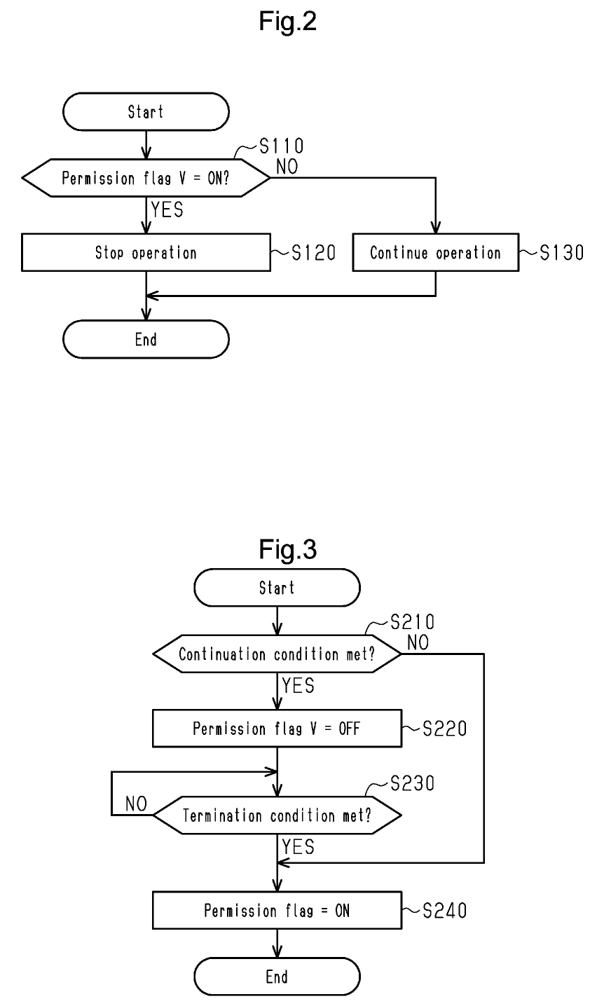

As shown in FIG. 2, when the CPU 91 starts the stopping process, the CPU 91 first performs the process of step S110. In step S110, the CPU 91 determines whether a permission flag V is ON. The permission flag V indicates whether the operation of the internal combustion engine 10 can be stopped. When the permission flag V is ON, it indicates that stopping operation of the internal combustion engine 10 is permitted. When the permission flag V is OFF, it indicates that stopping operation of the internal combustion engine 10 is prohibited. The memory 92 stores the current state of the permission flag V. If the permission flag V is ON (S110: YES), the CPU 91 advances the process to step S120.

In step S120, the CPU 91 stops the operation of the internal combustion engine 10. Specifically, the CPU 91 stops execution of the various controls for combustion of air-fuel mixture. In this manner, when the stop condition is met during operation of the internal combustion engine 10, the CPU 91 stops operation of the internal combustion engine 10 on condition that the permission flag V is ON. The process of step S120 is a fourth process. After executing the process of step S120, the CPU 91 ends the series of processes of the stopping process. When a predetermined start condition is met after operation of the internal combustion engine 10 is stopped, the CPU 91 restarts operation of the internal combustion engine 10. The start condition is, for example, that the vehicle requested torque is greater than the specified torque.

In contrast, when the permission flag V is OFF in step S110 (S110: NO), the CPU 91 advances the process to step S130. In step S130, the CPU 91 continues the operation of the internal combustion engine 10. Specifically, the CPU 91 maintains the execution state of various controls related to the operation of the internal combustion engine 10. Then, the CPU 91 promptly ends the process of step S130 and thus the stopping process. In other words, when the determination in step S110 is NO, the CPU 91 promptly ends the stopping process without performing any special process. In the case in which the determination in step S110 is NO, if the stop condition is met at the time of ending the stopping process, the CPU 91 performs the process of step S110 again.

The CPU 91 can execute a flag setting process. The flag setting process is a process for switching the permission flag V between ON and OFF. The CPU 91 starts the flag setting process on condition that the start switch 67 is in the ON state. In view of the contents of the flag setting process, the permission flag V is ON at the time when the CPU 91 starts the flag setting process.

As shown in FIG. 3, when the CPU 91 starts the flag setting process, the CPU 91 first performs a process of step S210. In step S210, the CPU 91 determines whether a continuation condition is met. The continuation condition is determined in advance as a condition indicating a sign of an anomaly related to the variation in air-fuel ratios across the cylinders 11. The CPU 91 performs the following process in step S210. First, the CPU 91 waits until a new imbalance index value X is calculated in a first process P1, which will be discussed below. Upon completion of the calculation of the new imbalance index value X, the CPU 91 retrieves a first value and a second value from among the imbalance index values X stored in time-series order in the memory 92. The first value is the most recent imbalance index value X that has just been calculated. The second value is a past imbalance index value X that precedes the first value by a prescribed number of samples. The prescribed number is, for example, two. The CPU 91 divides a value obtained by subtracting the second value from the first value by a continuation determination period. The CPU 91 treats the resulting value as an index rate of change. The index rate of change is a rate of change of the imbalance index value X during the continuation determination period. The continuation determination period is predetermined as the elapsed time from when the CPU 91 calculates the second value to when the CPU 91 calculates the first value. The CPU 91 calculates the length of the continuation determination period based on the respective calculation timings of the imbalance index values X stored in the memory 92. The duration of the continuation determination period may vary depending on the engine rotation speed, in conjunction with the execution time of the first process P1 described later. After calculating the index rate of change, the CPU 91 refers to the imbalance index values X stored in time-series order in the memory 92 to calculate an index average value. The index average value is the average of multiple imbalance index values X within the continuation determination period used for calculating the index rate of change. After calculating the index rate of change and the index average value, the CPU 91 determines whether a continuation condition is met. The continuation condition is that the index rate of change is greater than or equal to the continuation rate of change and the index average value is greater than or equal to the continuation determination value. The continuation rate of change and the continuation determination value are each predetermined based on experimentation or the like as values optimal for detecting a state in which the variations in air-fuel ratios across the cylinders 11 is expected to increase.

When the continuation condition is not met in the determination of whether the continuation condition is met (S210: NO), the CPU 91 advances the process to step S240. In step S240, the CPU 91 sets the permission flag V to ON. Then, the CPU 91 ends the series of processes of the flag setting process. If the start switch 67 is in the ON state at this time, the CPU 91 executes the process of step S210 again.

On the other hand, in step S210, when the CPU 91 determines that the continuation condition is met (S210: YES), the process proceeds to step S220. In step S220, the CPU 91 sets the permission flag V to OFF. Thereafter, the CPU 91 advances the process to step S230.

In step S230, the CPU 91 determines whether a termination condition is met. Specifically, the CPU 91 performs the following processes. The CPU 91 calculates the index rate of change in the same manner as in step S210. The prescribed number employed in step S230 may be the same as or different from the prescribed number employed in step S210. The prescribed number may be one, for example. In step S230, the CPU 91 divides the difference between the first value and the second value by a termination determination period instead of the continuation determination period. The termination determination period is predetermined as the elapsed time from when the CPU 91 calculates the second value to when the CPU 91 calculates the first value. The CPU 91 is capable of calculating the duration of the termination determination period in the same manner as the continuation determination period. In step S230, the CPU 91 calculates an adjustment rate of change, which is a rate of change of an adjustment coefficient Y2 during the termination determination period, in addition to the index rate of change. The adjustment coefficient Y2 will be described later. The CPU 91 refers to the most recent value of the adjustment coefficient Y2 and a past value of the adjustment coefficient Y2 that precedes the most recent value by a time interval equal to the termination determination period. These values are stored in time-series order in the memory 92. The CPU 91 calculates the adjustment rate of change by dividing the difference between the two values by the termination determination period. Thereafter, the CPU 91 determines whether the termination condition is met. The termination condition is that the absolute value of the index rate of change is less than or equal to an index determination value and the absolute value of the adjustment rate of change is less than or equal to an adjustment determination value. The index determination value is determined in advance based on experimentation or the like as a value at which the temporal variation in the imbalance index value X is considered sufficiently small. Similarly, the adjustment determination value is determined in advance based on experimentation or the like as a value at which the temporal variation in the adjustment rate of change is considered sufficiently small.

When the termination condition is not met in the determination of whether the termination condition is met (S230: NO), the CPU 91 executes the process of step S230 again. The CPU 91 repeats the process of step S230 until the termination condition is met. When the termination condition is met (S230: YES), the CPU 91 advances the process to step S240. The content of the process in step S240 is as described above. When the start switch 67 is switched from ON to OFF in the middle of repeating the process of step S230, the CPU 91 advances the process to step S240 at that time.

### Details of Injection Control

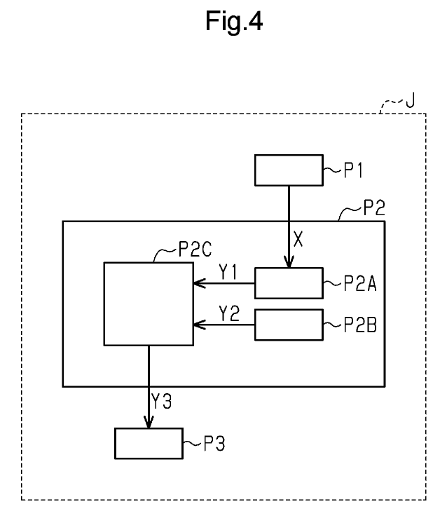

As shown in FIG. 4, the injection control J includes a first process P1, a second process P2, and a third process P3. The contents of these processes will be described in order.

The CPU 91 repeatedly executes the first process P1 when operating the internal combustion engine 10. In other words, the CPU 91 repeats the first process P1 during the operation of the internal combustion engine 10. The first process P1 is a process of calculating the imbalance index value X, which is information required in the second process P2. The imbalance index value X is an index value indicating the degree of variation in air-fuel ratios across the cylinders 11. The CPU 91 continues the first process P1 for a preset period determined in advance. When the preset period ends, the CPU 91 promptly starts the first process P1 of the next cycle. In other words, the CPU 91 executes the first process P1 once per each preset period. The preset period corresponds to a series of combustion cycles defined by a preset number of cycles. That is, the preset period is not defined by absolute time, but instead is determined in accordance with changes in the crank angle progression speed. In other words, the preset period changes according to the engine rotation speed. The preset number of cycles is determined through experimentation or the like as a minimum number of combustion cycles sufficient to obtain an average characteristic of the air-fuel ratio with reduced noise among the cylinders 11. Depending on the configuration of the preset number of cycles, the duration of a single execution of the first process P1 may be, for example, 10 seconds or longer. Prior to executing the first process P1, the CPU 91 repeatedly acquires output values from the upstream air-fuel ratio sensor 62, and thereby acquires the upstream air-fuel ratio AF1, at a predetermined sampling interval. The sampling interval is defined based on absolute time. A maximum value of the engine rotation speed that the internal combustion engine 10 can attain is referred to as the maximum speed. The sampling interval is set sufficiently shorter than one combustion cycle at the maximum speed of the engine rotation speed. The output value of the upstream air-fuel ratio sensor 62 is an example of a parameter indicative of the operation state of the internal combustion engine 10.

The CPU 91 calculates one imbalance index value X each time it executes the first process P1. The method for calculating the imbalance index value X is described below. During execution of the first process P1, the CPU 91 repeatedly calculates a basic index value. The basic index value is defined as the absolute value of the difference between two consecutively acquired upstream air-fuel ratios AF1, divided by the sampling interval of the output values from the upstream air-fuel ratio sensor 62. The CPU 91 calculates multiple basic index values during a single combustion cycle. The CPU 91 divides the cumulative sum of the multiple basic index values calculated during one combustion cycle by the cumulated number. The cumulated number is the number of basic index values calculated by the CPU 91 in one combustion cycle. The CPU 91 treats a value obtained by dividing the cumulative sum of the multiple basic index values by the cumulative number as an intermediate generated value. The CPU 91 calculates such an intermediate generated value for each of a preset number of combustion cycles. After calculating the intermediate generated values for the preset number of times, the CPU 91 divides the cumulative sum of the intermediate generated values for the preset number of times by the preset number of times. The CPU 91 stores the obtained value in the memory 92 as the most recent imbalance index value X. An example of the method for calculating the imbalance index value X is described in the section “Acquisition of Air-Fuel Ratio Imbalance Index Value” of JP2012-97671A. As described above, in the first process P1, the CPU 91 calculates the imbalance index value X based on changes in the output value from the upstream air-fuel ratio sensor 62 over the preset period. As can be seen from the calculation method of the basic index value, which is the basis of the imbalance index value X, the imbalance index value X increases as the degree of variation in air-fuel ratios across the multiple cylinders 11 increases. The memory 92 stores changes in the imbalance index value X in time series together with the calculation time of the imbalance index value X.

As shown in FIG. 4, the CPU 91 repeatedly executes the second process P2 when operating the internal combustion engine 10. In other words, the CPU 91 repeats the second process P2 during the operation of the internal combustion engine 10. The second process P2 is a process for calculating a target air-fuel ratio Y3, which is information required in the third process P3. The CPU 91 performs the second process P2 at predetermined execution intervals, such as once per combustion cycle. For example, the CPU 91 promptly performs the second process P2 at the start of each combustion cycle. In a single execution of the second process P2, the CPU 91 sequentially executes a correction amount calculation routine P2A, an adjustment coefficient calculation routine P2B, and a target value calculation routine P2C.

In the correction amount calculation routine P2A, the CPU 91 calculates a rich-side correction amount Y1. The rich-side correction amount Y1 is a correction value for reducing a reference air-fuel ratio AFK in the target value calculation routine P2C. The reference air-fuel ratio AFK of the present embodiment is predetermined to be the stoichiometric air-fuel ratio. However, a value other than the stoichiometric air-fuel ratio may also be set as the reference air-fuel ratio AFK. To calculate the rich-side correction amount Y1, the CPU 91 refers to the most recent intake air amount, the most recent imbalance index value X stored in the memory 92, and a correction map also stored in the memory 92. The correction map represents the relationship between the intake air amount, the imbalance index value X, and the rich-side correction amount Y1. The rich-side correction amount Y1 is a value greater than or equal to zero. The correction map basically has the following two characteristics. First, for a given intake air amount, the rich-side correction amount Y1 increases as the imbalance index value X increases. Secondly, for a given imbalance index value X, the rich-side correction amount Y1 increases as the intake air amount increases. The CPU 91 applies the most recent intake air amount and the most recent imbalance index value X to the correction map to calculate the rich-side correction amount Y1 corresponding to the current engine operating state. The CPU 91 stores the obtained value in the memory 92 as the most recent rich-side correction amount Y1. After calculating the rich-side correction amount Y1, the CPU 91 ends the correction amount calculation routine P2A. The CPU 91 may further multiply the rich-side correction amount Y1, obtained from the correction map, by a suitable correction factor and treat the result as the final rich-side correction amount Y1. An example of the method for calculating the rich-side correction amount Y1 is described in the section titled “Determination of Imbalance Rich-Side Correction Amount” of JP2012-97671A.

In the adjustment coefficient calculation routine P2B, the CPU 91 calculates the adjustment coefficient Y2. The adjustment coefficient Y2 is an example of an air-fuel ratio adjustment value. The adjustment coefficient Y2 is a coefficient for adjusting the degree of reduction of the reference air-fuel ratio AFK in the target value calculation routine P2C. To calculate the adjustment coefficient Y2, the CPU 91 compares the most recent output value from the downstream air-fuel ratio sensor 63 with a reference value. The reference value is predetermined as the value output by the downstream air-fuel ratio sensor 63 when the air-fuel ratio detected by the downstream air-fuel ratio sensor 63 is the reference air-fuel ratio AFK. That is, the reference value of the present embodiment is a value corresponding to the stoichiometric air-fuel ratio. If the output value from the downstream air-fuel ratio sensor 63 exceeds the reference value, the CPU 91 subtracts a first specified positive value from the previous value of the adjustment coefficient Y2 stored in the memory 92. The CPU 91 stores the obtained value in the memory 92 as a new adjustment coefficient. In contrast, when the output value from the downstream air-fuel ratio sensor 63 is less than the reference value, the CPU 91 adds the first specified value to the previous value of the adjustment coefficient Y2 stored in the memory 92. The CPU 91 stores the obtained value in the memory 92 as a new adjustment coefficient Y2. When the output value from the downstream air-fuel ratio sensor 63 is equal to the reference value, the CPU 91 uses the previous value of the adjustment coefficient Y2 stored in the memory 92 a new adjustment coefficient Y2. In this manner, the CPU 91 updates the adjustment coefficient Y2 based on the result of comparison between the output value of the downstream air-fuel ratio sensor 63 and the reference value. The memory 92 stores a time-series record of the adjustment coefficient Y2 together with the time of calculation of the adjustment coefficient Y2. For example, the upper limit value and the lower limit value of the air-fuel ratio adjustment value are determined so as to be a positive value less than or equal to 1. After calculating the new air-fuel ratio adjustment value, the CPU 91 ends the adjustment coefficient calculation routine P2B. The adjustment coefficient Y2 corresponds to the “fourth reflection rate” of JP2012-97671A. An example of the method for calculating the adjustment coefficient Y2 is described in the section titled “Calculation of Correction Amount for Imbalance Rich-Side Correction Amount” of JP2012-97671A.

In the target value calculation routine P2C, the CPU 91 calculates the target air-fuel ratio Y3. The CPU 91 calculates the target air-fuel ratio Y3 based on the most recent rich-side correction amount Y1, the most recent adjustment coefficient Y2, and the reference air-fuel ratio AFK. To calculate the target air-fuel ratio Y3, the CPU 91 first multiplies the rich-side correction amount Y1 by the adjustment coefficient Y2. The CPU 91 treats the obtained value as a post-adjustment correction amount. According to the definitions of the rich-side correction amount Y1 and the adjustment coefficient Y2, the post-adjustment correction amount is a positive value. After calculating the post-adjustment correction amount, the CPU 91 subtracts the post-adjustment correction amount from the reference air-fuel ratio AFK. The CPU 91 further subtracts a sub-feedback correction amount and a startup correction amount from the obtained value. The CPU 91 stores the obtained value in the memory 92 as the most recent target air-fuel ratio Y3. Then, the CPU 91 ends the target value calculation routine P2C. The sub-feedback correction amount is the sum of the outputs of a proportional element, an integral element, and a differential element, to which the value obtained by subtracting the output value of the downstream air-fuel ratio sensor 63 from the reference value is input. The startup correction amount is determined based on the temperature of the coolant in the engine main body 10A during engine startup. The CPU 91 calculates the sub-feedback correction amount and the startup correction amount in other processing routines as a part of the second process P2. An example of the method for calculating the target air-fuel ratio Y3 is described in the section titled “Determination of Target Air-Fuel Ratio” of JP2012-97671A. An example of the method for calculating the sub-feedback correction amount is described in the section titled “Calculation of Sub-Feedback Amount” of JP2012-97671A. An example of the method for calculating the startup correction amount is described in the section titled “Determination of Startup Correction Amount” of JP2012-97671A.

The following observations may be made regarding the second process P2. As described above, the rich-side correction amount Y1 and thus the post-adjustment correction amount are positive values. Accordingly, calculating the post-adjustment correction amount from the reference air-fuel ratio AFK in the target value calculation routine P2C corresponds to reduction of the reference air-fuel ratio AFK. That is, in calculating the target air-fuel ratio Y3, the CPU 91 reduces the reference air-fuel ratio AFK based on the rich-side correction amount Y1. As described above, in the correction map, the rich-side correction amount Y1 increases the imbalance index value X increases. That is, the CPU 91 calculates the target air-fuel ratio Y3 such that the degree of reduction of the reference air-fuel ratio AFK increases as the imbalance index value X increases. The CPU 91 uses a value obtained by multiplying the rich-side correction amount Y1 by the adjustment coefficient Y2 to reduce the reference air-fuel ratio AFK. That is, the CPU 91 adjusts the degree of reduction of the reference air-fuel ratio AFK using the adjustment coefficient Y2. The CPU 91 calculates the target air-fuel ratio Y3 by changing the degree of reduction of the reference air-fuel ratio AFK in accordance with the most recent adjustment coefficient Y2.

As shown in FIG. 4, the CPU 91 repeatedly executes the third process P3 when operating the internal combustion engine 10. In other words, the CPU 91 repeats the third process P3 during the operation of the internal combustion engine 10. The CPU 91 performs the third process P3 for each combustion cycle.

In each execution of the third process P3, the CPU 91 performs an injection process routine once for each of the cylinders 11. Any of the four cylinders 11 will now be referred to as a subject cylinder. The following description explains the injection process routine using the subject cylinder as an example. When the crank angle reaches a specified value before the intake top dead center of the subject cylinder, the CPU 91 initiates the injection process routine for the subject cylinder. Upon initiating the injection process routine, the CPU 91 first calculates the current in-cylinder intake air amount in the subject cylinder. The in-cylinder intake air amount is an intake air amount charged into a single cylinder 11. The CPU 91 calculates the in-cylinder intake air amount based on the most recent intake air amount and the most recent engine rotation speed. After calculating the in-cylinder intake air amount, the CPU 91 refers to the most recent target air-fuel ratio Y3 stored in the memory 92. Then, CPU 91 divides the in-cylinder intake air amount by the target air-fuel ratio Y3. The CPU 91 treats the obtained value as a base injection amount. After calculating the base injection amount, the CPU 91 performs feedback correction on the base injection amount. Specifically, the CPU 91 multiplies the base injection amount by a main feedback coefficient, which has been calculated in a process routine different from the injection process routine, and a main learning value, which is a learning value of the main feedback coefficient. The CPU 91 treats the obtained value as the commanded injection amount. The main feedback coefficient and the main learning value are correction values for preforming feedback-correction on the fuel injection amount from the fuel injection valves 17 such that the upstream air-fuel ratio AF1 agrees with the target air-fuel ratio Y3. By multiplying the base injection amount by these correction values, the CPU 91 compensates for any excess or deficiency in the amount of fuel supplied to the cylinders 11 in order to cause the upstream air-fuel ratio AF1 to agree with the target air-fuel ratio Y3. An example of the method for calculating the main feedback coefficient and the main learning value is described in the section titled “Main Feedback Control” of JP2012-97671A. An example of the method for calculating the commanded injection amount is described in the section titled “Fuel Injection Amount Control” of JP2012-97671A. After calculating the commanded injection amount, the CPU 91 causes the fuel injection valve 17 to inject the commanded injection amount at a crank angle corresponding to a predetermined injection timing. Once fuel injection by the fuel injection valve 17 is complete, the CPU 91 ends the injection process routine. The CPU 91 performs this injection process routine for each cylinder 11 within a single combustion cycle. In other words, in the third process P3, the CPU 91 causes each of the fuel injection valves 17 to inject the commanded injection amount corresponding to the most recent target air-fuel ratio Y3 within one combustion cycle. In the present embodiment, the commanded injection amount is the same for all fuel injection valves 17. As a result of the CPU 91 repeating the third process P3, fuel is supplied to each of the cylinders 11 in each combustion cycle.

Operation and Advantages of the Embodiment

(1) When the condition for continuing the operation of the internal combustion engine 10 is met (S210: YES), the CPU 91 turns off the permission flag V (S220). When the stop condition of the internal combustion engine 10 is met in this situation, the CPU 91 continues the operation of the internal combustion engine 10 without stopping the operation of the internal combustion engine 10 until the termination condition is met (S130). The CPU 91 repeats the first process P1, the second process P2, and the third process P3 while continuing the operation of the internal combustion engine 10. With such a configuration, when there is a sign that the variations in air-fuel ratios across the cylinders 11 increases, the CPU 91 updates the imbalance index value X without delay even under a situation in which the internal combustion engine 10 is to be intermittently stopped. Therefore, the imbalance index value X always reflects the variation in air-fuel ratios across the cylinders 11 at the current time point. Thus, the CPU 91 can always set the optimum target air-fuel ratio Y3 from the viewpoint of suppressing the exhaust emission.

(2) When the time average value of the imbalance index value X is large to some extent and the time rate of change of the imbalance index value X is large to some extent, there is a high possibility that the variation in air-fuel ratios across the cylinders 11 will increase thereafter. Therefore, the adoption of the continuation condition that the index rate of change is greater than or equal to the continuation rate of change and the index average value is greater than or equal to the continuation determination value in the present embodiment is suitable for capturing a sign that the variation in air-fuel ratios across the cylinders 11 increases.

(3) The average value of the actual air-fuel ratios in the multiple cylinders 11 is referred to as a true average air-fuel ratio. As described in JP2012-97671A, in view of the structure of the upstream air-fuel ratio sensor 62, the upstream air-fuel ratio sensor 62 can indicate a value richer than the true average air-fuel ratio when the variation in air-fuel ratios across the cylinders 11 increases. On the other hand, when performing feedback correction so that the upstream air-fuel ratio AF1 matches the target air-fuel ratio Y3, the CPU 91 performs correction to decrease the fuel injection amount so as to eliminate the rich air-fuel ratio indicated by the upstream air-fuel ratio sensor 62. As a result, the true average air-fuel ratio may be leaner than the reference air-fuel ratio AFK. Such a correction for making the air-fuel ratio lean is referred to as a lean erroneous correction. In order to compensate for the erroneous lean correction, the CPU 91 sets the target air-fuel ratio Y3 by correcting the reference air-fuel ratio AFK to be decreased based on the imbalance index value X. If the update of the imbalance index value X is delayed due to the intermittent stop of the internal combustion engine 10, such a situation where the erroneous lean correction cannot be compensated for continues. As described in (1), the CPU 91 of the present embodiment updates the imbalance index value X without delay. Therefore, the CPU 91 can avoid the erroneous lean correction even in a situation where the intermittent stop of the internal combustion engine 10 is repeated.

(4) As described in JP2012-97671A, the difference between the outputted value of the downstream air-fuel ratio sensor 63 and the reference value reflects the degree of excess or deficiency of the decreasing correction related to the calculation of the target air-fuel ratio Y3. Therefore, the CPU 91 of the present embodiment can set the target air-fuel ratio Y3 corresponding to the imbalance index value X to an optimum value for suppressing the exhaust emission by adjusting the degree of the decrease correction related to the target air-fuel ratio Y3 by the adjustment coefficient Y2.

Assume that one of the fuel injection valves 17 is clogged with foreign matter. Then, the amount of fuel supplied from the fuel injection valve 17 to the cylinder 11 becomes smaller than the commanded injection amount and thus the amount of fuel supplied to the other cylinders 11. For example, it is assumed that the variation in air-fuel ratios across the cylinders 11 increases with time due to such a situation. Thereafter, when the degree of the variation gradually becomes stable, the fluctuation of the imbalance index value X gradually decreases. Thereafter, when the adjustment coefficient Y2 converges to an optimum value, the downstream air-fuel ratio sensor 63 outputs a value closer to the reference value. Through such a series of processes, it takes a certain amount of time for the output value of the downstream air-fuel ratio sensor 63 to substantially match the reference value. If the intermittent stop and the short operation period of the internal combustion engine 10 are repeated, a situation in which the adjustment coefficient Y2 cannot be converged to a value required for bringing the detection value of the downstream air-fuel ratio sensor 63 close to the reference value may continue. In this regard, the CPU 91 of the present embodiment updates the adjustment coefficient Y2 together with the imbalance index value X without delay. Therefore, the CPU 91 can promptly set the adjustment coefficient Y2 to an optimum value even in a situation where the intermittent stop of the internal combustion engine 10 is normally repeated.

### Modifications

The above-described embodiment may be modified as follows. The above-described embodiment and the following modifications can be combined as long as the combined modifications remain technically consistent with each other.

The imbalance index value X and the method of calculating the imbalance index value X are not limited to the example of the embodiment. The imbalance index value X may be any value that indicates the degree of variation in air-fuel ratios across the cylinders 11. In calculating the imbalance index value X, a parameter indicating an engine operation state other than the upstream air-fuel ratio AF1, such as the engine rotation speed, may be used.

The content of the second process P2 is not limited to the example of the above embodiment. The second process P2 may be a process of calculating the target air-fuel ratio Y3 by correcting the reference air-fuel ratio AFK based on the imbalance index value X. For example, the reference air-fuel ratio AFK may be corrected to increase. In calculating the target air-fuel ratio Y3, one or more of the rich-side correction amount Y1, the adjustment coefficient Y2, the sub-feedback correction amount, and the startup correction amount may not be used. Calculation of parameters that are not used for correction may be omitted.

The content of the third process P3 is not limited to the example of the above embodiment. The third process P3 may be a process of causing each of the fuel injection valves 17 to inject the commanded injection amount corresponding to the target air-fuel ratio Y3. When calculating the commanded injection amount, it is not essential to perform feedback correction so that the upstream air-fuel ratio AF1 matches the target air-fuel ratio Y3. The commanded injection amount may be changed for each cylinder 11.

The continuation condition is not limited to the example of the above embodiment. The continuation condition may be any condition as long as it indicates a sign that the variation in air-fuel ratios across the cylinders 11 increases. The continuation condition may be determined by a parameter other than the imbalance index value X.

The termination condition is not limited to the example of the above embodiment. The termination condition may be a condition in which the imbalance index value X can be updated to some extent. The sub-feedback correction amount may be handled as the air-fuel ratio adjustment value. As the termination condition, the rate of change of the sub-feedback correction amount may be compared with a dedicated adjustment determination value. The termination condition may be determined by only one of the imbalance index value X and the air-fuel ratio adjustment value, or the termination condition may be determined by a parameter other than these.

The overall configuration of the internal combustion engine 10 is not limited to the example of the above embodiment. The internal combustion engine 10 may include multiple cylinders 11 and a fuel injection valve 17 provided for each cylinder 11. The number of the cylinders 11 is not limited to four. The upstream air-fuel ratio sensor 62 and the downstream air-fuel ratio sensor 63 may be sensors of the same type.

The overall configuration of the vehicle 100 is not limited to the example of the above embodiment. One or more generator motors may be removed from the vehicle 100. If the controller 90 is applied to the vehicle 100 that performs automatic stop and automatic restart of the internal combustion engine 10, it is suitable for updating the imbalance index value X.

The controller 90 is not limited to being realized by processing circuitry including the CPU 91 and the memory 92. For example, the controller 90 may include a dedicated hardware circuit (for example, an ASIC or the like) that executes at least some of the processes executed in the above-described embodiment. That is, the controller 90 may be modified as long as it includes processing circuitry that has any one of the following configurations (a) to (c).

(a) Processing circuitry including at least one processor that executes all of the above-described processes according to programs and at least one program storage device such as a ROM that stores the programs.

(b) Processing circuitry including at least one processor and at least one program storage device that execute part of the above-described processes according to the programs and at least one dedicated hardware circuit that executes the remaining processes.

(c) Processing circuitry including at least dedicated hardware circuit that executes all of the above-described processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for an internal combustion engine, the internal combustion engine including an engine main body having multiple cylinders, and fuel injection valves provided for the respective cylinders, wherein
the controller comprises processing circuitry,
the processing circuitry is configured to execute, during operation of the internal combustion engine:
a first process that calculates an imbalance index value indicating a degree of variation in air-fuel ratios across the cylinders based on changes in a parameter indicating an operation state of the internal combustion engine in a preset period determined in advance;
a second process that calculates a target air-fuel ratio by correcting a predetermined reference air-fuel ratio based on the most recent imbalance index value;
a third process that causing each of the fuel injection valves to inject fuel in a commanded injection amount corresponding to the most recent target air-fuel ratio; and
a fourth process that stops the operation of the internal combustion engine when a predetermined stop condition is met, and
the processing circuitry is configured to repeat, when a predetermined continuation condition is met, the first process, the second process, and the third process without stopping the operation of the internal combustion engine until a predetermined termination condition is met even if the stop condition is met, the continuation condition being a condition indicating a sign of an anomaly related to variations in air-fuel ratios across the cylinders.

2. The controller for the internal combustion engine according to claim 1, wherein the continuation condition is that a rate of change of the imbalance index value during a predetermined continuation determination period is greater than or equal to a predetermined continuation rate of change, and an average value of the imbalance index value during the continuation determination period is greater than or equal to a predetermined continuation determination value.

3. The controller for the internal combustion engine according to claim 1, wherein
the internal combustion engine further includes:
an exhaust passage configured to allow exhaust gas from the cylinders to flow therethrough, the exhaust passage including individual passages extending from the respective cylinders and a merging point at which the individual passages merge with each other;
a three-way catalyst disposed in a portion of the exhaust passage downstream of the merging point; and
an upstream air-fuel ratio sensor configured to output a value corresponding to an air-fuel ratio of the exhaust gas flowing through a portion of the exhaust passage between the merging point and the three-way catalyst,
the first process includes calculating the imbalance index value based on changes in the output value of the upstream air-fuel ratio sensor such that the imbalance index value increases as the degree of variations in air-fuel ratios across the cylinders increases,
the second process includes calculating the target air-fuel ratio such that a degree of reduction of the reference air-fuel ratio increases as the imbalance index value increases,
the third process includes calculating the commanded injection amount by performing feedback correction such that the air-fuel ratio of the exhaust gas flowing into the three-way catalyst agrees with the target air-fuel ratio, and
the termination condition is that an absolute value of a rate of change of the imbalance index value during a predetermined termination determination period is less than or equal to a predetermined index determination value.

4. The controller for the internal combustion engine according to claim 3, wherein
the internal combustion engine further includes a downstream air-fuel ratio sensor configured to output a value corresponding to an air-fuel ratio of exhaust gas flowing through a portion of the exhaust passage downstream of the three-way catalyst,
the second process includes:
calculating, based on a result of comparison between the output value of the downstream air-fuel ratio sensor and a predetermined reference value, an air-fuel ratio adjustment value for adjusting the degree of reduction of the reference air-fuel ratio; and
calculating the target air-fuel ratio by changing the degree of reduction of the reference air-fuel ratio in accordance with the calculated air-fuel ratio adjustment value, and
the termination condition is that an absolute value of a rate of change of the air-fuel ratio adjustment value during the termination determination period is less than or equal to a predetermined adjustment determination value, in addition to that the absolute value of the rate of change of the imbalance index value during the termination determination period is less than or equal to the index determination value.
